(19) United States
(12) Patent Application Publication
(10) Pub. No.: US 2015/0217740 A1
(43) Pub. Date: Aug. 6, 2015

(54) BRAKE CONTROL SYSTEM FOR A UTILITY VEHICLE HAVING A TRAILER

(71) Applicant: Knorr-Bremse Systeme Fuer Nutzfahrzeuge GmbH, Muenchen (DE)

(72) Inventors: Falk Hecker, Markgroeningen (DE); Gerhard Wieder, Besigheim (DE); Adnan Mustapha, Maulbronn (DE)

(21) Appl. No.: 14/428,609

(22) PCT Filed: Sep. 16, 2013
(86) PCT No.: PCT/EP2013/069116

§ 371 Date: Mar. 16, 2015

(30) Foreign Application Priority Data
Sep. 17, 2012 (DE) 102012108702.4

(51) Int. Cl. B60T 8/17; B60T 8/48; B60T 8/24

(52) U.S. Cl. CPC B60T 8/1708; B60T 8/245; B60T 8/4818

(57) ABSTRACT

A brake control device for a utility vehicle having a trailer, including: a pneumatic brake control circuit having a vehicle pressure path to output a brake pressure to a vehicle brake which brakes the utility vehicle, based on a target input of a driver of the utility vehicle, and having a trailer pressure path for outputting the brake pressure to a trailer brake, which brakes the trailer, on the basis of the target input; and a pneumatic start assist circuit to output a further brake pressure to a trailer brake of the trailer based on a speed of the utility vehicle, in which the pneumatic start assist circuit is pneumatically connected to the trailer pressure path of the pneumatic brake control circuit.

### FIELD OF THE INVENTION

The present invention relates generally to vehicles and, in particular, utility vehicles. Furthermore, the invention relates to a brake control device for a utility vehicle having a trailer.

### BACKGROUND INFORMATION

German patent document DE 10 2010 039 301 A1 discusses a hill start assist system, also referred to as HSA for hill start aid. Such a hill start assist system assists a driver of a utility vehicle when starting on gradients, which driver must simultaneously keep the vehicle stationary with the foot brake, open the throttle and activate the clutch at the same time.

### SUMMARY OF THE INVENTION

It is an object of the invention to provide an improved hill start assist system.

The object may be achieved by the features of the independent claims. Developments are the subject matter of the further descriptions herein.

According to one aspect of the invention, a brake control device for a utility vehicle having a trailer comprises:
a pneumatic brake control circuit having a vehicle pressure path for outputting a brake pressure to a vehicle brake which brakes the utility vehicle, on the basis of a target input of a driver of the utility vehicle, and having a trailer pressure path for outputting the brake pressure to a trailer brake, which brakes the trailer, on the basis of the target input, and
a pneumatic start assist circuit for outputting a further brake pressure to a trailer brake of the trailer on the basis of a speed of the utility vehicle,
wherein the pneumatic start assist circuit is pneumatically connected to the trailer pressure path of the pneumatic brake control circuit.

The specified brake control device is based on the idea that the hill start assist system mentioned at the beginning could be operated by the anti-lock brake system, referred to as the ABS and/or the traction control system, referred to as the TCS, which systems are present only in the towing vehicle but not in the trailer. For technical reasons, within the scope of the hill start assist system only the drive axle should be braked, as a result of which, however, the hill start assist system comes up against its limits relatively quickly relatively large gradients and in the case of heavy loads, which can be manifested in the fact that an applied brake pressure exclusively at the drive axle is not sufficient to keep the vehicle stationary, with the result that the vehicle could roll backwards.

Therefore, within the scope of the specified brake control device it is proposed that the brake pressure which is built up at the drive axle for the hill start assist system should also be passed onward to the trailer, with the result that the trailer is also braked and therefore relatively large gradients and loads can be kept stationary. In this way, a reduction in the brake pressure level would be possible, since the trailer itself brakes its load, as a result of which a reduced stress for components of the brake system of the utility vehicle which are connected downstream and reduced air consumption can be achieved.

In one development, the specified brake control device comprises a shuttle valve for outputting the brake pressure or the further brake pressure to the trailer brake, on the basis of the level thereof. A shuttle valve, which is also referred to as a “select high valve” is understood to mean two non-return valves which are connected together in an anti-serial fashion counter to their non-return direction.

Therefore, a flow of compressed air from the common port of the two non-return valves to the respective remaining separate ports of the two non-return valves is avoided, but permitted in the opposing direction. The shuttle valve therefore ensures a compressed air flow exclusively from the vehicle pressure path or the start assist circuit into the trailer pressure path, but not in any other direction.

In one particular development, the specified brake control device comprises a pressure valve which is provided for adjusting a level of the further brake pressure. This pressure valve can be embodied, for example, as an actuator element of a control circuit which adjusts the level of the brake pressure on the basis of whether the utility vehicle is moving, with the result that a minimum necessary brake pressure is always set within the scope of the hill start assist system in order to keep the utility vehicle stationary. In a particularly favorable way, the minimum necessary pressure is reduced here by the specified brake control device the minimum necessary pressure, since the trailer is also actively involved in the brake operation, with the result that a relatively low overall force is necessary to brake the utility vehicle with the trailer, which results in automatic adaptation of the brake pressure within the control circuit.

In one development of the specified brake control device, the pressure valve is an actuator element of a traction control system, which permits more versatile use of this traction control system actuator element.

In another development, the specified brake control device comprises a switching element which is configured to pass on the further brake control pressure to the vehicle brake.

This switching element can be configured, on the one hand, to actuate two anti-lock brake system valves at two vehicle brakes of an axle of the utility vehicle simultaneously.

Together with the TCS valve, the hill start assist system is therefore also integrated into the ABS/TCS system of the utility vehicle.

In a particularly favorable way, a double shut-off valve is therefore configured to pass the further brake pressure between the brake control circuit and the start assist circuit via the pneumatic connection of the further brake pressure is applied simultaneously to the two vehicle brakes. A double shut-off valve, also referred to as a “select low valve”, is to be understood below as meaning a valve with two inputs and one output which, from two pressures present at the input, selects the lower of the two pressures. During normal operation of the ABS/TCS system, when the two vehicle wheels are only braked individually and therefore the brake pressure at the inputs of the double shut-off valve differs, the double shut-off valve prevents brake pressure from being passed on into the trailer pressure path. This occurs only if within the scope of the hill start assist system the two vehicle wheels are actuated synchronously by the ABS with the result that the same brake pressure is present at the inputs of the double shut-off valve, which brake pressure can then be passed on to the trailer pressure path. In this way, the TCS function and the hill start assist system are kept separated from one another and do not influence one another mutually. If the utility vehicle as a towing vehicle of the trailer is constructed with three axles, such a double shut-off valve for passing on the pressure is present in any case, with the result that the specified brake control device can easily be constructed from a conventional brake control device plus a shuttle valve, a branch element downstream of the double shut-off valve and a few meters of compressed air line.

In an alternative or additional development of the specified brake control device, the switching element comprises a shuttle valve which is configured to select the further brake pressure. This development is based on the idea that integrating the hill start assist system into the ABS system of the vehicle makes the vehicle pressure path virtually ineffective if the hill start assist system intervenes. The driver of the utility vehicle can then no longer increase the brake pressure further, since the ABS valves are located in the vehicle pressure path. This disadvantage is countered by the fact that the brake pressure for the hill start assist system is selected from another pressure path than the pressure for the ABS system.

In one development of the specified brake control device, the switching element is configured to select between a traction control pressure and a reduced traction control pressure.

According to a further aspect of the specified invention, a utility vehicle comprises a vehicle wheel, a vehicle brake for braking the vehicle wheel and a specified brake control device for actuating the vehicle brake. A trailer can be connected to the utility vehicle, at which trailer braking is then not only carried out in the case of a brake actuation by the driver but also in the case of a braking intervention by the hill start assist system. However, the trailer does not necessarily have to be coupled to the specified utility vehicle.

The properties, features and advantages of this invention which are described above as well as the manner in which they are achieved become more apparent and clearly comprehensible in conjunction with the following description of the exemplary embodiments which are explained in more detail in connection with the drawings.

### BRIEF DESCRIPTION OF THE DRAWINGS

FIG. 1 shows a dual-circuit brake system of a utility vehicle with a front axle and two rear axles.

FIG. 2 shows the second brake circuit from FIG. 1 according to a first embodiment.

FIG. 3 shows the second brake circuit from FIG. 1 according to a second embodiment.

### DETAILED DESCRIPTION

In the figures, identical technical elements are provided with identical reference symbols and described only once.

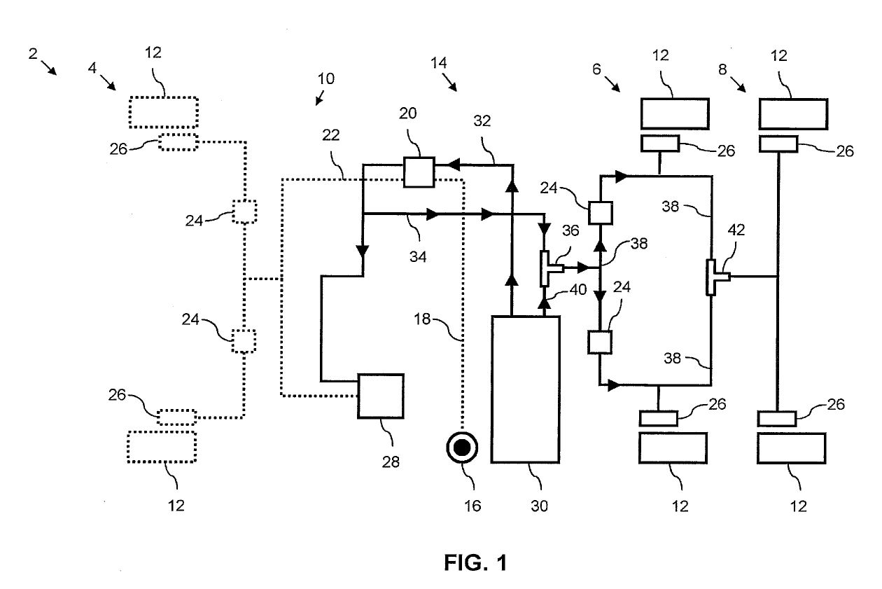

Reference is made to FIG. 1 which shows a dual-circuit brake system 2 of a utility vehicle (not illustrated in detail) with a front axle 4 and two rear axles 6, 8. Here, the first rear axle 6 is located upstream of the second rear axle 8 viewed from the front axle 4. The utility vehicle can also be constructed with two axles, details of which are given here at the correspondingly relevant points in the following description.

In the present embodiment, the dual-circuit brake system 2 comprises a first brake circuit 10 for braking the wheels 12 on the front axle 4, which is indicated in FIG. 1 by dotted lines. A second brake circuit 14 of the dual-circuit brake system 2, which is indicated by continuous lines in the figures, is provided for braking the wheels 12 on the two rear axles 6, 8. In the present embodiment, for the sake of simplicity control brake pressures and supply brake pressures are combined to form a brake pressure. However, this combination does not have any influence on the principle of action of the invention.

The first brake control circuit 10 is supplied with a first pneumatic source pressure 18 from a pressure source 16. This first pneumatic source pressure 18 is set into a first pneumatic brake pressure 22 in a manner known to a person skilled in the art, by an actuator element 20, which can be activated by a driver of the utility vehicle and is to be considered below as a brake pedal 20. The first pneumatic brake pressure 22 is finally output, via ABS valves 24 described below, to brakes 26 which are intended to brake the wheels 12 of the front axle 4. In addition, the first pneumatic brake pressure 22 is applied to a trailer interface 28 in order to activate brakes (not shown) of a trailer which is connected to the utility vehicle. The trailer interface 28 is embodied in such a way that a pressure loss does not occur if there is no trailer connected to the utility vehicle.

The second brake control circuit 14 is supplied in the present embodiment from a source pressure circuit 30 (described below) with a second pneumatic source pressure 32 which is independent of the first pneumatic source pressure 18. As in the first brake control circuit 10, the second pneumatic source pressure 32 is adjusted, by the brake pedal 20, to a second pneumatic brake pressure 34, which can then be used, in a manner described below, to actuate the brakes 26 of the wheels 12 on the two rear axles 6, 8. In addition, the second pneumatic brake pressure 34 is applied again to the trailer interface 28. In this way, a dual-circuit brake system 2 is provided with which the driver can still brake the utility vehicle even if a pressure loss occurs in one of the two brake circuits 10, 14.

The second pneumatic brake pressure 34 is applied to a shuttle valve 36 which selects a pneumatic actuation pressure 38 between the pneumatic brake pressure 34 and a TCS brake pressure 40 depending on which of the two pressures is higher. The TCS brake pressure 40 is output within the scope of a traction control process which is known per se, which TCS brake pressure 40 must be independent of the second pneumatic brake pressure 34 which is predefined by the driver by the brake pedal 20. The selected pneumatic actuation pressure 38 is then applied again via the ABS valves 28 (described below) to the brakes 26 of the wheels 12 of the first rear axle 6.

The second rear axle 8 is optional, as already described. If the second rear axle 8 is present, the pneumatic actuation pressures 38 which are output by the ABS valves 24 are applied to a double shut-off valve 42 which, of these two pneumatic actuation pressures 38, always supplies the lower of the two pneumatic actuation pressures 38 to the brakes 26 of the wheels 12 of the second rear axle 8.

The ABS valves 24 are part of an anti-lock brake system which is known per se to a person skilled in the art. Said anti-lock brake system is configured to prevent locking of the individual brakes 26 by selective actuation thereof. For this reason, an ABS valve 24 is also arranged upstream of each brake of the front axle 4 and of the first rear axle 6 in the pressure direction. If the anti-lock brake system intervenes in a braking process at the first rear axle 6, the two brakes 26 on the first rear axle 6 are supplied via the ABS valves with pneumatic actuation pressures 38 with different levels, which actuation pressures 38 are separated from one another by the double shut-off valve 42 if the second rear axle 8 is present. The lower of the two pneumatic actuation pressures 38 is then output to the brakes 26 of the second rear axle 8. This has no effect on a normal braking process without ABS intervention, since pneumatic actuation pressures 38 of equal magnitude are then present at the double shut-off valve 42 and said actuation pressures 38 have only a negligibly small pressure difference, if any at all.

Within the scope of the present embodiment, a hill start assist system which keeps the utility vehicle stationary on a gradient by the brakes 26 and which releases the brakes 26 as soon as the driver of the utility vehicle accelerates said vehicle can also be implemented with the second brake circuit 14. The hill start assist system can close the brakes 26 of the first rear axle 6 and, if appropriate, also of the second rear axle 8 if the latter is present, if the utility vehicle undershoots a predetermined speed, for example of zero, and can open said brakes 26 if the utility vehicle is to be moved, for example, with a torque of a predetermined level.

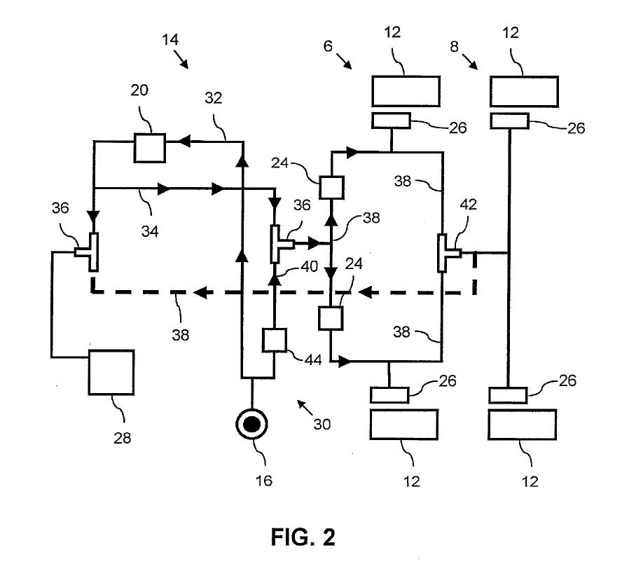

Reference is made to FIG. 2 which shows the second brake circuit 14 from FIG. 1 with a first embodiment of the hill start assist system.

In the present embodiment, the hill start assist system is implemented with the ABS valves 24. For this purpose, the source pressure circuit 30, which is illustrated only schematically in FIG. 1, has a pressure source 16 which outputs the second pneumatic source pressure 32. In addition, the second pneumatic source pressure is also applied a TCS valve 44 which converts the second pneumatic source pressure 32 into the TCS pressure 40 within the scope of the traction control system specified above.

In the case of an intervention by the hill start assist system which is to take place independently of the brake pedal 20, the TCS valve 44 predefines the pneumatic pressure as a pneumatic actuation pressure 38 for the hill start assist system independently of the brake pedal 20. By the ABS valves 24, the pneumatic actuation pressure 38 is then set at both brakes 26 simultaneously to a suitable level with which the utility vehicle can be securely kept stationary on the gradient.

In the present embodiment, in the case of a braking intervention by the hill start assist system the pneumatic actuation pressure 38 is to be passed onto the trailer interface 28. For this purpose, the double shut-off valve 42 is arranged independently of whether the second rear axle 8 is present or not. The double shut-off valve 42 separates the two brakes 26 of the first rear axle 6 from one another pneumatically if a customary ABS intervention takes place, but passes on the pneumatic actuation pressure 38 via a line (illustrated by dashed lines in FIG. 2) to the trailer interface 28 if the brakes 26 are actuated by the hill start assist system within the scope of a conventional brake intervention or the brake intervention.

In the present embodiment, a shuttle valve 36 can be arranged between the brake pedal 20 and the trailer interface 28, which shuttle valve 36 passes on either the second pneumatic brake pressure 34 or the pneumatic actuation pressure 38 to the trailer interface 28 depending on which of the two pressures is higher.

In this respect, in order to implement the present invention, only the additional pneumatic line (illustrated by dashes in FIG. 2) and the shuttle valve 36 would be necessary to pass on the pneumatic actuation pressure 38 also to the trailer of the utility vehicle within the scope of the hill start assist system. If the utility vehicle does not have a second rear axle 8, an additional double shut-off valve 42 would be additionally necessary.

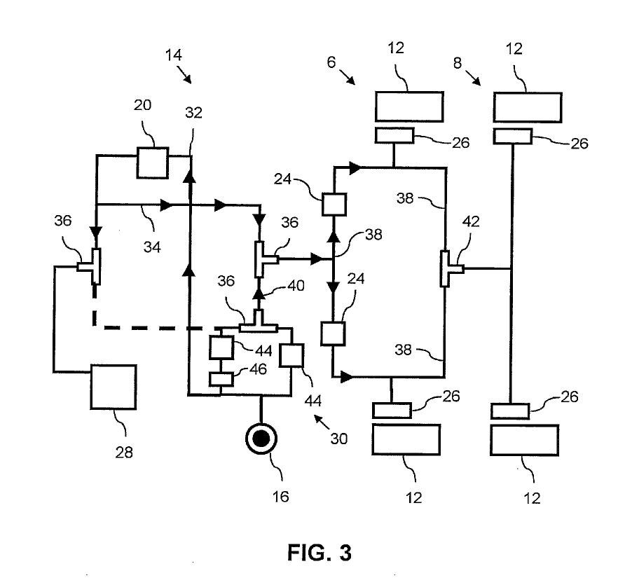

Reference is made to FIG. 3 which shows the second brake circuit 14 from FIG. 1 with a first embodiment of the hill start assist system.

In the present embodiment, the hill start assist system is implemented with a pressure limiter 46 which limits the second pneumatic source pressure 32 and passes it on into a TCS valve 44 which is provided specially for the hill start assist system. The limited pressure from the corresponding TCS valve 44 and the unlimited pressure from the other TCS valve 44 are compared at an additional shuttle valve 36, and the higher pressure of the two is then converted later into the pneumatic actuation pressure 38 in the manner described. Either the one pneumatic pressure or the other pneumatic pressure is present at the additionally introduced shuttle valve 36.

In the present embodiment, the output pressure which is limited by the pressure limiter 46 is output from the corresponding TCS valve 44 to the shuttle valve 36 additionally introduced in FIG. 2, via a line which is illustrated by dashes in FIG. 3. At this point, the background of the shuttle valve 36 between the two TCS valves 44 can be seen, which shuttle valve prevents outputting of a pneumatic pressure to the trailer interface 28 if a customary TCS intervention takes place.

Although the present embodiment is more complex in technical terms than the embodiment in FIG. 2, the advantage of the present embodiment is that the hill start assist system is embodied independently of the ABS valves 24, with the result that the latter therefore do not have to be actuated (and stressed).

1-10. (canceled)

11. A brake control device for a utility vehicle having a trailer, comprising:
a pneumatic brake control circuit having a vehicle pressure path to output a brake pressure to a vehicle brake which brakes the utility vehicle, based on a target input of a driver of the utility vehicle, and having a trailer pressure path for outputting the brake pressure to a trailer brake, which brakes the trailer, on the basis of the target input; and
a pneumatic start assist circuit to output a further brake pressure to a trailer brake of the trailer based on a speed of the utility vehicle;
wherein the pneumatic start assist circuit is pneumatically connected to the trailer pressure path of the pneumatic brake control circuit.

12. The brake control device of claim 11, further comprising:
a shuttle valve to output the brake pressure or the further brake pressure to the trailer brake, based on the level thereof.

13. The brake control device of claim 11, wherein the start assist circuit includes a pressure valve which is for adjusting a level of the further brake pressure.

14. The brake control device of claim 13, wherein the pressure valve is an actuator element of a traction control system.

15. The brake control device of claim 11, further comprising:
a switching element to pass on the further brake control pressure to the vehicle brake.

16. The brake control device of claim 15, wherein the switching element is configured to actuate two anti-lock brake system valves at two vehicle brakes of an axle of the utility vehicle simultaneously.

17. The brake control device of claim 15, wherein the switching element includes a shuttle valve configured to select the further brake pressure.

18. The brake control device of claim 17, wherein the switching element is configured to select between a fraction control pressure and a reduced traction control pressure.

19. The brake control device of claim 11, further comprising:
a double shut-off valve to pass the further brake pressure between the brake control circuit and the start assist circuit via the pneumatic connection if the further brake pressure is applied simultaneously to the two vehicle brakes.

20. A utility vehicle having a trailer, comprising:
a vehicle wheel;
a vehicle brake to brake the vehicle wheel; and
a brake control device brake control device, including:
a pneumatic brake control circuit having a vehicle pressure path to output a brake pressure to a vehicle brake which brakes the utility vehicle, based on a target input of a driver of the utility vehicle, and having a trailer pressure path for outputting the brake pressure to a trailer brake, which brakes the trailer, on the basis of the target input; and
a pneumatic start assist circuit to output a further brake pressure to a trailer brake of the trailer based on a speed of the utility vehicle;
wherein the pneumatic start assist circuit is pneumatically connected to the trailer pressure path of the pneumatic brake control circuit.
